(19) United States
(12) Patent Application Publication
(10) Pub. No.: US 2016/0357921 A1
(43) Pub. Date: Dec. 8, 2016

(54) COMPUTERIZED SYSTEM AND METHOD TO USE PAYER FINANCIAL TRANSACTIONS TO BUILD A CLINICAL INTERVENTION PLAN USING A DERIVED PATIENT SCHEDULE

(71) Applicant: Humana Inc., Louisville, KY (US)

(72) Inventors: Bruce D. Perkins, Louisville, KY (US); Ahmed Ghouri, San Diego, CA (US)

(73) Assignee: Humana Inc., Louisville, KY (US)

(21) Appl. No.: 14/215,614

(22) Filed: Mar. 17, 2014

Related U.S. Application Data
(60) Provisional application No. 61/789,925, filed on Mar. 15, 2013.

(51) Int. Cl. G06F 19/00

(52) U.S. Cl. CPC G06F 19/328

(57) ABSTRACT

The present invention is a system and method for providing medical care information to medical care providers identified through the analysis of electronic requests for reimbursement where such information may comprise treatment advice.

### CROSS-REFERENCE TO RELATED APPLICATIONS

This application claims priority to provisional application 61/789,925, filed on Mar. 15, 2013 and is herein incorporated by reference in its entirety.

### BACKGROUND OF THE INVENTION

Electronic Medical Records (EMR) systems used by medical care providers frequently have incomplete information regarding care received from other care providers (cross-provider care). Similarly EMRs also may have incomplete information with regard to care provided by other care institutions (cross-institution care). Such incomplete information may result in the provision of incomplete or ineffective medical care by a medical care provider relying on such an EMR system.

Clinical messaging systems provide care related messages to medical care providers. Such messages may be based on data derived from payment of claims by insurers. Because insurers generally receive all medical care claims submitted by their members, such claim data by its very nature includes cross-provider and cross-institution care information. As a result, clinical messaging systems using such data may be able to provide messaging that provides cross-provider and cross-institution care information to the recipient of such messaging. A common shortfall of clinical messaging systems is that the messages may be delivered long before or long after a patient is seen by a medical care provider. Messages sent long before a patient is seen by a medical care provider may be filed in a patient's medical record and become out-of-date or inadvertently missed during a patient visit to a medical care provider. Messages sent after a patient's visit to a medical care provider are not available to assist a medical care provider's provision of care to a patient.

Electronic eligibility checking is a method of confirming a patient's insurance coverage and eligibility for treatment. In such a method, a medical care provider may submit patient information to that patient's insurer at the time a patient schedules an appointment with such a medical care provider. When the request is received by the insurer, the insurer may provide coverage and eligibility information for the patient to the requesting medical care provider. This response provides the medical care provider with information helpful to the determination of what care may be provided in the most economical way to the patient.

Messages generated by clinical messaging systems may be provided to a medical care provider at the same time as electronic eligibility checking. Because a medical care provider may see as many as thirty patients each day, messages that arrive at the time of a single patient undergoing electronic eligibility checking generally are not well organized and may create additional information management challenges for physicians and other medical care providers.

### SUMMARY OF THE INVENTION

The present disclosure is directed to a system and method of providing organized and aggregated clinical messaging to a medical care provider to assist that medical care provider in the provision of care to patients.

A first embodiment may, using electronic eligibility check transactions, generate a predicted doctor-patient schedule of visits. Such an embodiment may organize patient information from this predicted doctor-patient schedule into a list of predicted patient visits that may occur during a selectable time period.

A second embodiment of the invention may, using eligibility check transactions, generate a summary of expected patient encounters organized into a daily summary and further organize clinical messages related to their patients into desired actions to be taken for the patients expected during the summary period.

A third embodiment may, using eligibility check transactions, generate a daily checklist for patient visits that are predicted to occur during a selectable time period. Such an embodiment may also append concise actions to be taken with regard to drug safety, coding accuracy, detected gaps in care, occurrences of non-adherence to recommended medication regimens, and/or identified cost savings opportunities.

These and other unmet advantages are provided by the system and method described and shown in more detail below.

### BRIEF DESCRIPTION OF THE DRAWINGS

A better understanding of the disclosed embodiments will be obtained from a reading of the following detailed description and the accompanying drawings wherein identical reference characters refer to identical parts and in which:

FIG. 1 is flow diagram showing the steps in the electronic eligibility process;

FIG. 2 is a diagram of a computer system and network for performing an embodiment of the invention;

FIG. 3 is a flow chart of the steps of an embodiment of the invention;

FIG. 4 is a chart illustrating a partial listing of raw data used by an embodiment of the invention;

FIG. 5 is a chart illustrating a partial listing of member's attributed to a listing of physicians;

FIG. 6 is a weekly member visit report generated for a physician by an embodiment of the invention; and

FIG. 7 is an illustration of an embodiment of a user interface which provides additional details regarding member health alerts and treatment eligibility.

### DETAILED DESCRIPTION

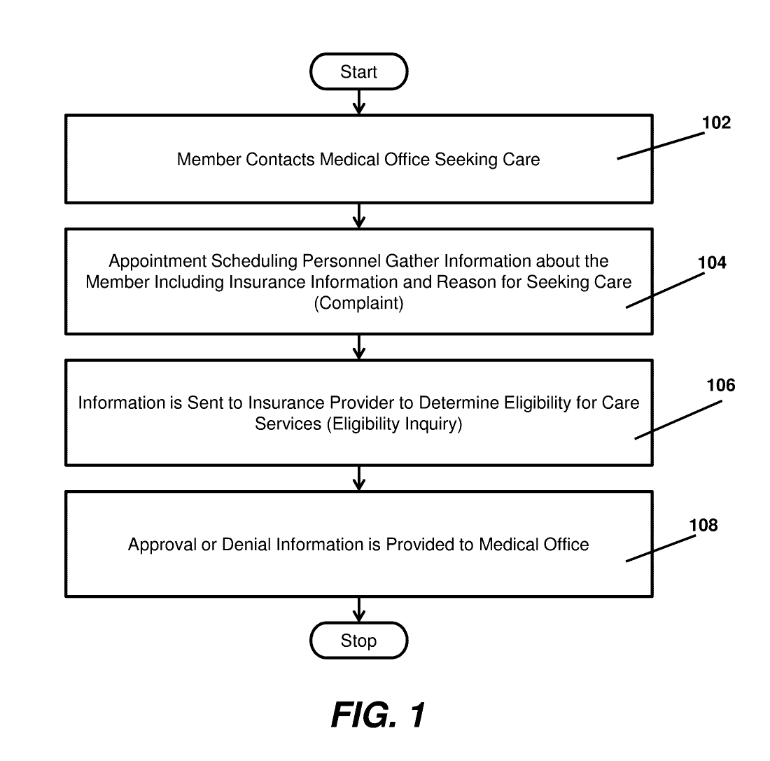

As is illustrated by the flow chart of FIG. 1, when a person seeking care (which may be referred to herein as a patient or member, reflecting membership in an care insurance plan) seeks care from a physician, that patient may contact a medical office with which the physician is associated and schedule an appointment 102. During the process of scheduling an appointment the office personnel may obtain insurance information from a patient 104 and contact that patient's insurer to determine the patient's eligibility for care 106. During this process, the patient's reason for seeking care (complaint) may be provided to the insurer. Depending upon the type and extent of the insurance coverage held by a patient, the insurer may approve or deny all or certain aspects of the care for payment. Such information may be provided to the medical office 108.

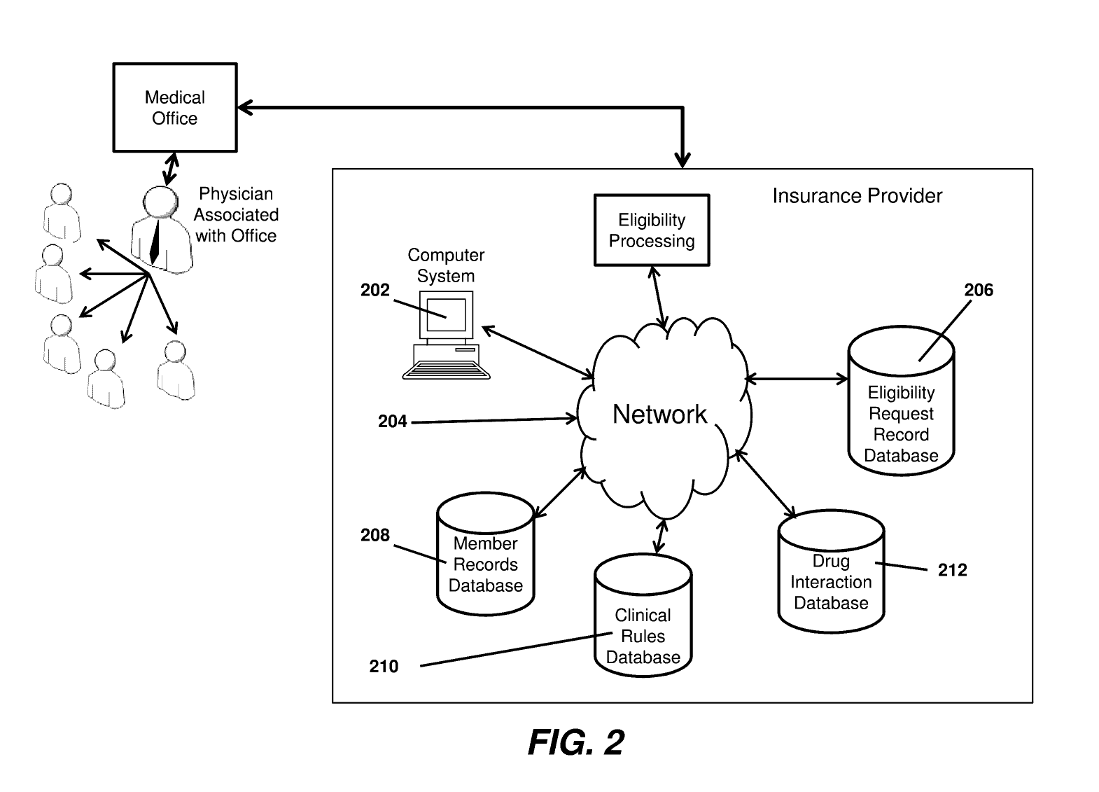

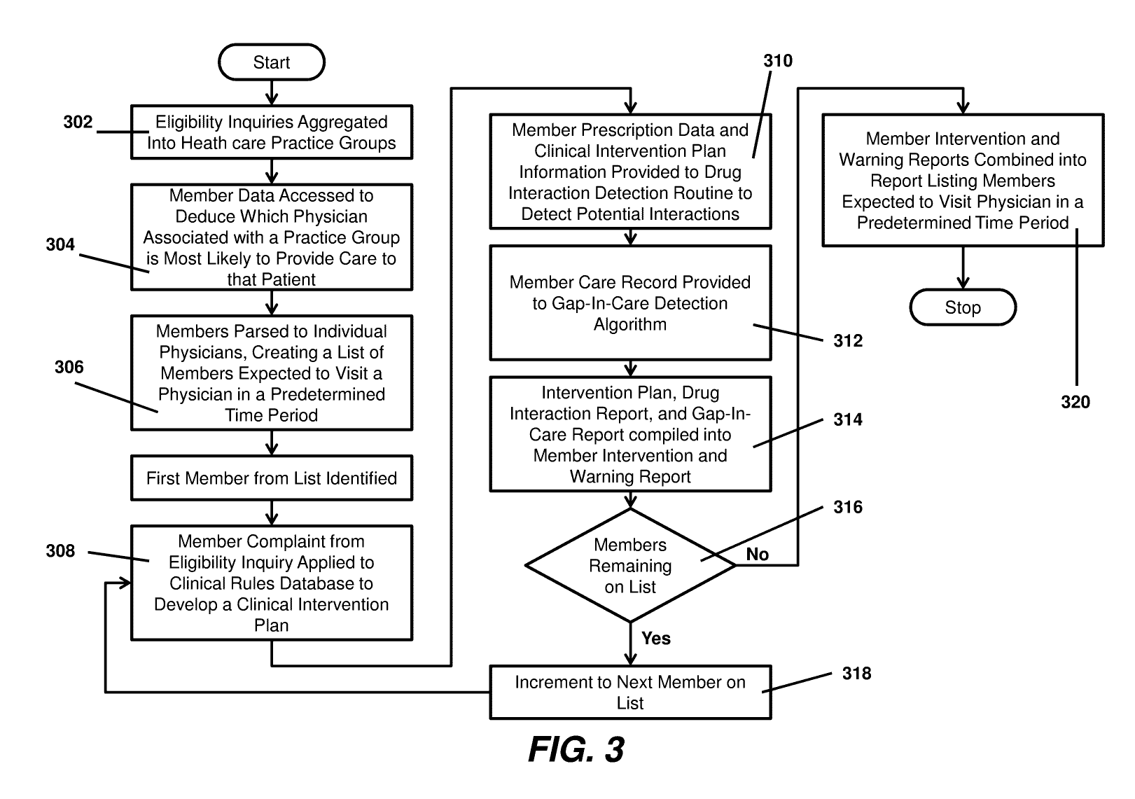

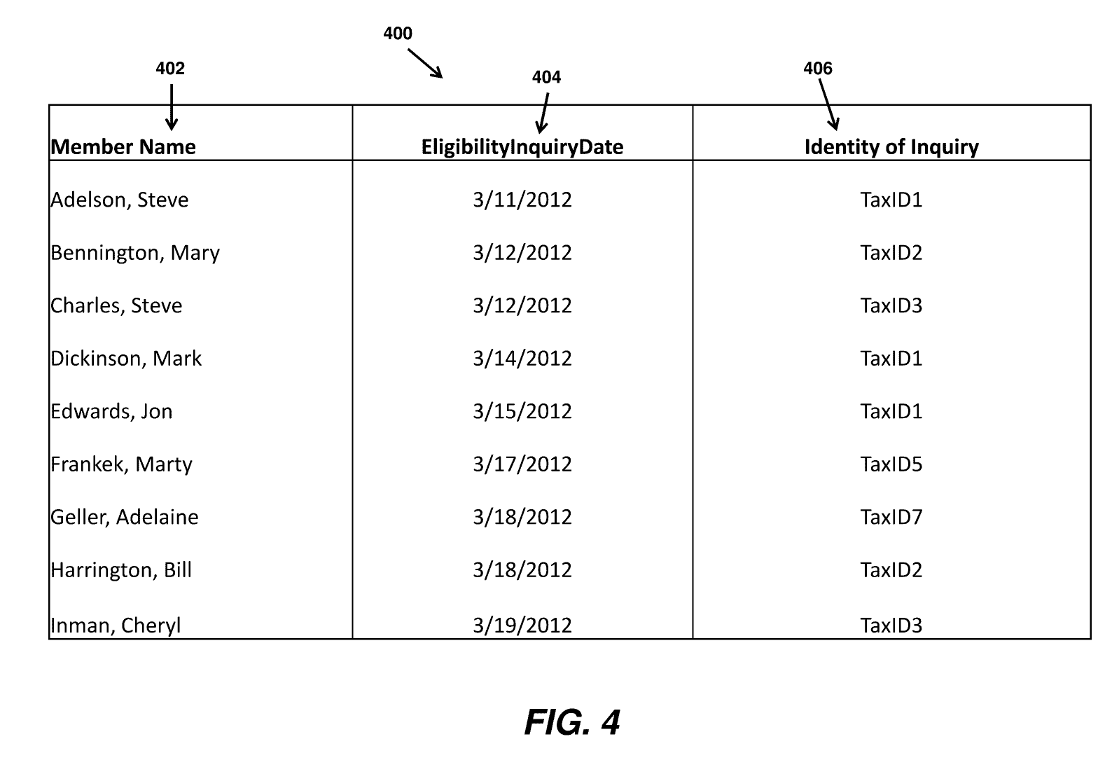

As is illustrated in FIG. 2, in an embodiment of the invention, when a medical office inquiry results in an eligibility request, a system comprising a computer system 202, network 204, eligibility request database 206, member records database 208, clinical rules database 210 and drug interaction database 212 may be used to implement the disclosed features and functionality. Referring to FIG. 3, which illustrates a flow chart of an embodiment of the invention, in step 302 the computer system 202 may aggregate eligibility inquires into groups identified with health care practices. FIG. 4 illustrates a table of such inquiries 400 where the first column 402 lists member names, the second column 404 lists the date of inquiry, and the third column 406 lists unique patient identifiers associated with the organization from which the eligibility inquiry originated.

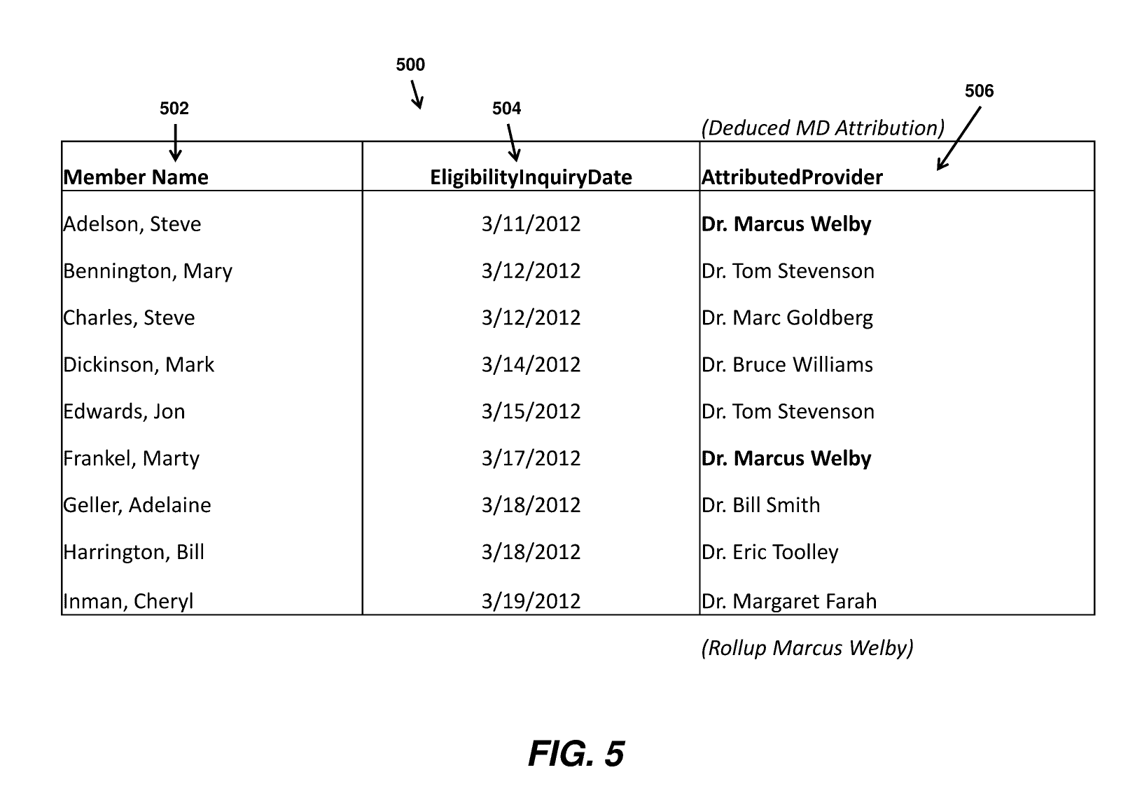

Referring again to FIG. 3, in step 304 member data may be accessed from the member records database 208 to deduce which physician associated with the practice is most likely to provide care to the member. This deduction may be based on records of past member visits, patient symptoms, physician availability, physician expertise, and other data contained in the member records database. FIG. 5 illustrates a table generated after the deduction process has been performed 500. Such a table may contain member names 502, eligibility inquiry dates 504, and a list of physicians attributed to the members pending visits 506 derived through the deduction process described above.

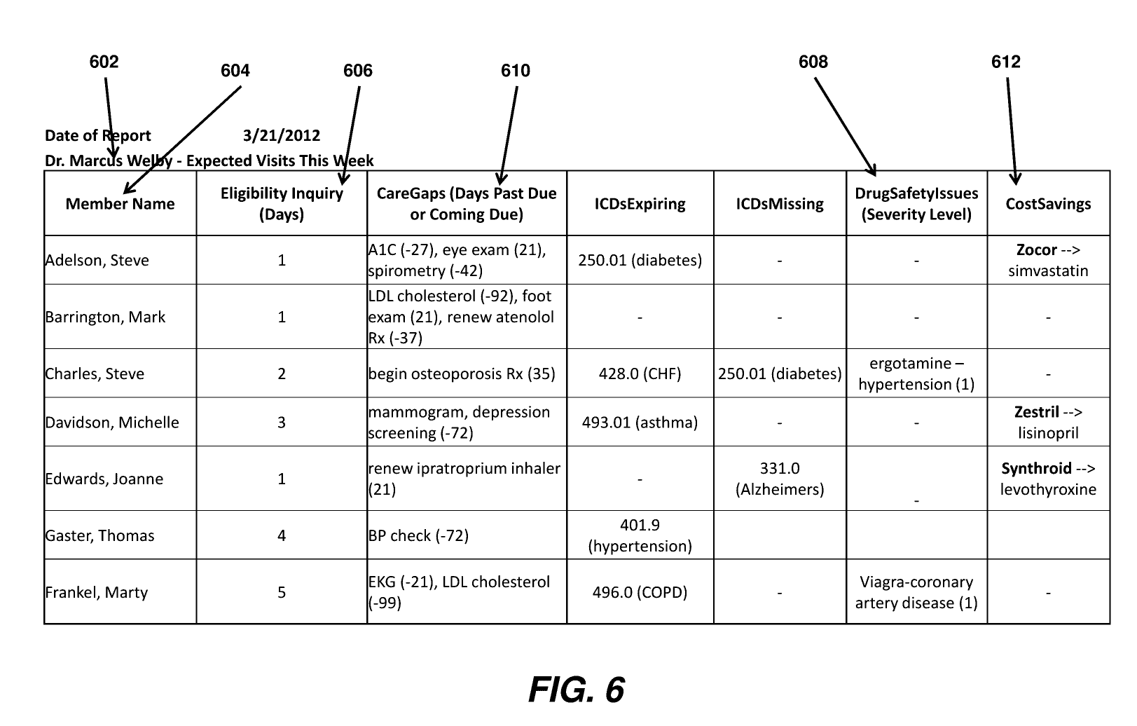

Referring again to FIG. 3, in step 306, the list of members may be parsed such that a subset of the members attributed to one of the physicians is created. The list may then be sorted based upon members predicted to visit a physician during a predetermined time period. Such predictions may be made using typical time frames between eligibility checks and patient visits to such a physician, batch-mode medical records processing, or through the use of analytic tools provided by practice management software systems. FIG. 6 illustrates an exemplary chart of expected visits over a week-long period 600. The illustrated chart is limited to one physician 602, and lists member names 604, and the number of days since an eligibility inquiry was received by the insurer 606. Similar charts may be generated for multiple physicians or other care providers and arranged by location, practice area, or other factors as may be useful for the viewer. For instance, a person responsible for scheduling appointments for a number of care providers at a location may wish to have a chart that lists those care providers at the location for which the person is scheduling appointments.

A clinical messaging process may provide patient care suggestions to a physician based upon patient data, but as was previously noted, current messaging systems are not configured to provide such messages in a timeframe relevant to the patient visit. In an embodiment of the invention, information from an eligibility inquiry may be provided to a clinical rules database (shown in step 308 of FIG. 3). Such a database may provide suggested physician actions based on factors which may comprise the member health complaint associated with the eligibility inquiry, and member health and claim information available to an insurer from a member records database 208. An embodiment of the invention may include this clinical messaging in a chart of expected member visits as described above and illustrated in FIG. 6. By presenting clinical messages in a chart of expected member/patient visits, the messages may be conveniently organized in a manner that does not require a physician to search through a member's records just prior to consulting with such a member. Another embodiment of the invention may generate a summary of expected member encounters organized into a daily summary and further organize clinical messages into desired actions (a clinical intervention plan) to be taken for the members who are expected to visit the physician during the summary period. Such a chart may allow a physician to review predicted member visits for a period of time in advance, providing time to secure needed resources or research a particular health complaint.

Embodiments of the invention may add additional data to time period summaries. Members predicted to see a physician may be subjected to additional analysis steps to allow for the provision of additional treatment suggestions and care alerts. As illustrated in FIG. 3 at step 310, the records of a member from the list identified to visit a physician may be analyzed for potential drug interactions. Such data may result from eligibility inquiries, clinical intervention plans, and member treatment history and that is provided to a drug interaction analysis process. Such a process may identify potential drug interactions and provide alerts to treating physicians. Such alerts may be included in a physician's summary as shown in FIG. 6 at 608. A level of severity may be included in such an alert to help the physician to respond appropriately to the patient health risk presented by the identified interaction.

Another embodiment of the invention may include gap-in-care alerts. Such alerts may be generated by an algorithm that analyzes past member care data to detect recommended treatments, follow-ups, or other care items that have not been provided or are due in the near future. When a member appears on a list of members expected to visit a physician, that member's record of past care may be provided to a gap in care algorithm 312 which analyzes the member's record of care. The algorithm may generate alerts warning of missed or upcoming care. Such alerts may be included in a chart of expected member visits to a physician as illustrated in FIG. 6 in the gap in care section 610 of such a chart.

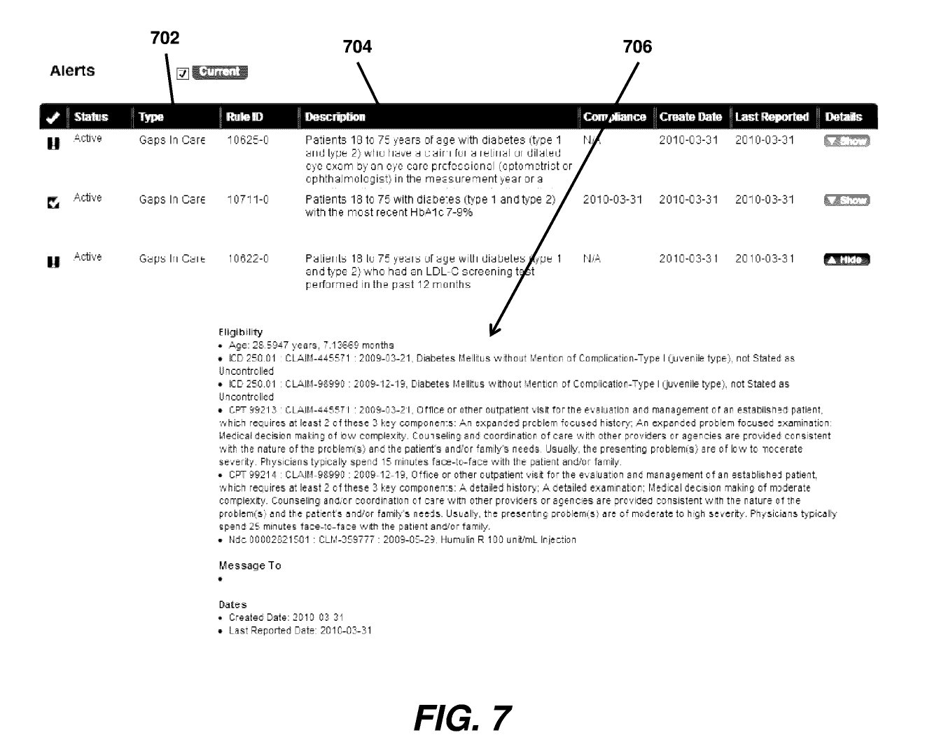

Another embodiment of the invention may provide information that allows a physician reviewing a chart of expected member visits to view additional information related to a member or view gap in care, drug interaction, or other alerts in greater detail. An exemplary embodiment of the invention may present such greater detail in a user interface as illustrated in FIG. 7. As illustrated, the type of alert may be indicated 702, a description of the alert, including greater detail may be displayed 704. To provide a physician with additional information regarding the alerts, the date of creation, last reporting of the alert, and member compliance may be displayed in such a user interface. Additional member data may be presented along with alert data to assist with a physician's diagnoses and treatment of member health concerns 706.

Referring to again to FIG. 3, an embodiment of the invention may generate an intervention plan, drug interaction report, and gap-in-care report for each member expected to visit a physician during an identified time period. Such a process is illustrated in steps 314, 316, and 318.

As shown in step 320, an embodiment of the invention may combine clinical intervention plans, drug interaction reports, and gap-in-care alert reports into a daily report. Such a report may contain a daily checklist to assist with managing member visits. Such an embodiment may also append concise actions to be taken with regard to drug safety, coding accuracy, detected gaps in care, and occurrences of non-adherence to recommended medication regimens. An embodiment of the invention may analyze current member treatment regimens using information such as best practices databases and medication formularies to identify cost savings opportunities. FIG. 6 illustrates an embodiment of cost saving recommendations 612 in the form of generic drug alternatives identified from a member's medical history. Such history may be obtained from member claim data or electronic medical records data provided by a physician.

Having shown and described a preferred embodiment of the invention, those skilled in the art will realize that many variations and modifications may be made to affect the described invention and still be within the scope of the claimed invention. Thus, many of the elements indicated above may be altered or replaced by different elements which will provide the same result and fall within the spirit of the claimed invention. It is the intention, therefore, to limit the invention only as indicated by the scope of the claims.

What is claimed is:

1. A computerized system for providing medical care information to medical care providers, comprising:
a health insurance eligibility for reimbursement computerized subsystem, configured to enable a care provider to request eligibility for reimbursement from a health insurance carrier for a particular form of care for a member of said carrier's health insurance plan, said subsystem in a first location available to said care provider;
a health insurance computer network at a second location available to said carrier, and in electronic communication with said care provider's computerized subsystem, said network is in electronic communication with at least one database containing medical data related to said requested form of care for said member;
an electronic request for eligibility for reimbursement on behalf of said care provider and said member, received at said network; and
an electronic advice notification automatically generated by said network in response to said request, and sent to said care provider's computerized subsystem, said notification including care advice for said member, wherein said care advice is other than reimbursement eligibility, and is based, at least in part, on medical data about said member stored in said at least one database.

2. The computerized system of claim 1, wherein said care advice comprises a recommended treatment plan derived using data contained in said at least one database and a description of said particular care for which eligibility for reimbursement was requested.

3. The computerized system of claim 2, wherein said at least one database comprises a clinical rules database containing data comprising recommended medical care to be provided to a patient when such a patient exhibits certain symptoms.

4. The computerized system of claim 1, wherein said care advice comprises a drug interaction report.

5. The computerized system of claim 4, wherein said drug interaction report is generated using a patient care record contained in at least one said database and a list of drugs found in a recommended treatment plan where such recommended treatment plan is derived at least in part using data contained in said at least one database and data comprising member symptoms found in said electronic request for eligibility for reimbursement.

6. The computerized system of claim 5, wherein said recommended treatment plan is derived from treatment recommendations retrieved from a clinical rules database using member health complaint data obtained from said electronic request for eligibility for reimbursement.

7. The computerized system of claim 1, wherein said care advice comprises a report listing gaps in care provided to said member.

8. The computerized system of claim 7 where said report listing missing member care is generated by comparing recommended treatment plans derived from member medical data comprised of past diagnoses with treatments received obtained from member medical data comprised of claims for medical care received by said member.

9. A computerized system for providing medical care information to medical care providers, comprising:
a health insurance eligibility for reimbursement, computerized subsystem, configured to enable a care provider to request eligibility for reimbursement from a health insurance carrier for care requested on behalf of members of said carrier's health insurance plan, said subsystem in a first location available to said care provider;
a health insurance computer network at a second location available to said carrier, and in electronic communication with said care provider's computerized subsystem, said network in electronic communication with at least one database containing medical data related to said requested form of care for said member;
at least one electronic request for reimbursement on behalf of said care provider and at least one member, received at said network; and
an electronic advice notification automatically generated by said network and sent to said care provider's computerized subsystem, said notification comprising a prediction of care to be required by said at least one member during a predetermined time period.

10. The computerized system of claim 9, wherein said prediction of care is generated using data retrieved from a clinical rules database in electronic communication with said network.

11. The computerized system of claim 9, where said database also comprises a list of care provider resources associated with said care provider's computerized subsystem and where said prediction of care also comprises a predicted care provider resource chosen from said list of provider resources associated with said care provider's computerized subsystem.

12. A computerized method of providing medical care information to medical care providers comprising the steps of:
receiving, at a computer system, at least one request for eligibility for reimbursement on behalf of a member of an insurance care plan;
receiving, at the computer system, medical data related to the at least one request for eligibility made, from at least one database;
generating care advice, where said care advice is other than reimbursement eligibility for said member, by configuring the computer system to perform software steps to processing the received data; and
automatically generating an electronic advice notification comprised of said generated care advice.

13. The computerized method of claim 12, where to step of processing the received data to generate care advice comprises the step of automatically generating a recommended treatment plan.

14. The computerized method of claim 12, where the step of receiving, at the computer system, medical data related to the at least one request for eligibility made comprises the steps of:
receiving member health records comprised of past diagnoses, prescribed treatments and results;
receiving, from a clinical rules database, a list of recommended treatment plans; and
processing the received recommended treatment plans, received member health records, and the type of care requested to be reimbursed from the received request for reimbursement to determine a recommended treatment plan.

15. The computerized method of claim 12, where to step of processing the received data to generate care advice comprises the step of automatically generating a drug interaction report from drugs identified in the step of receiving, at the computer system, medical data related to the at least one request for eligibility.

16. The computerized method of claim 15, where the step of receiving, at the computer system, medical data related to the at least one request for eligibility made comprises the steps of:
receiving a member health record comprised of previously prescribed drugs;
receiving, from a clinical rules database, a list of recommended treatment plans;
processing the received recommended treatment plans, received member health records, and the type of care requested to be reimbursed from the received request for reimbursement to determine a recommended treatment plan;
further processing said recommended treatment plan to identify drugs included in said plan; and
generating a drug interaction report using the identified potential drug interactions.

17. The computerized method of claim 12, where to step of processing the received data to generate care advice comprises the steps of:
analyzing said received data to detect gaps in care provided to said member; and
automatically generating gap in care report for said member for inclusion in said generated care advice.

18. The computerized method of claim 12, where the step of generating care advice comprises the steps of:
analyzing a request for eligibility to identify the treatment(s) to be provided to the member;
retrieving a list of care providing resources associated with a computerized subsystem from which said request for eligibility was received;
processing said list to identify care providing resources which provide said identified treatment;
automatically generating a list of identified treatment(s) and at least one said care providing resources which provides such treatment.
